(19) United States
(12) Patent Application Publication
(10) Pub. No.: US 2025/0350325 A1
(43) Pub. Date: Nov. 13, 2025

(54) COMMUNICATION METHOD AND COMMUNICATION APPARATUS

(71) Applicant: HUAWEI TECHNOLOGIES CO., LTD., Shenzhen (CN)

(72) Inventors: Yong Liu, Shanghai (CN); Xiaoyan Bi, Shanghai (CN); Chenglong Jiang, Shanghai (CN)

(73) Assignee: HUAWEI TECHNOLOGIES CO., LTD., Shenzhen (CN)

(21) Appl. No.: 19/273,978

(22) Filed: Jul. 18, 2025

Related U.S. Application Data
(63) Continuation of application No. PCT/CN2023/073396, filed on Jan. 20, 2023.

(51) Int. Cl. H04B 7/0456; H04L 5/00

(52) U.S. Cl. CPC H04B 7/0456; H04L 5/0048

(57) ABSTRACT

A network device determines a first resource grid. The first resource grid includes N second resource grids. Each second resource grid supports mapping M different reference signal antenna ports. The multiplexing manners of the M different reference signal antenna ports in each of the N second resource grids are the same. The network device outputs a reference signal based on the first resource grid.

### CROSS-REFERENCE TO RELATED APPLICATIONS

This application is a continuation of International Application No. PCT/CN2023/073396, filed on Jan. 20, 2023, the disclosure of which is hereby incorporated by reference in its entirety.

### TECHNICAL FIELD

This application relates to the field of wireless communication, and to a communication method and a communication apparatus with enhanced reference mapping of reference signals in a multiple-input multiple-output (MIMO) environment.

### BACKGROUND

A multiple-input multiple-output (MIMO) technology is one of the key technologies in 5th generation (5G) communication and future communication. When data is transmitted by using the MIMO technology, a receive end device may perform channel estimation based on a received reference signal (for example, a demodulation reference signal (DMRS)).

In a current solution, a reference signal supports a maximum of 12 orthogonal ports, that is, an existing system can implement simultaneous transmission of a maximum of 12 orthogonal data streams. However, in a future communication scenario with a larger antenna dimension, more data streams may need to be transmitted. For example, hundreds or thousands of data streams are simultaneously transmitted. A current solution cannot meet this requirement.

### SUMMARY

This application provides a communication method and a communication apparatus, which can map a reference signal more flexibly, thereby supporting simultaneous transmission of more data streams.

According to a first aspect, a communication method is provided. The method may be performed by a transmit end. The transmit end may be a communication device, or may be a component (such as a chip or a chip system) used for a communication device. This is not limited in this application. The transmit end is a transmit end of a reference signal and data, and may be located on a network side, or may be located on a terminal side.

The method may include: The transmit end determines a first resource grid. The first resource grid includes N second resource grids, the second resource grid supports mapping M different reference signal antenna ports, multiplexing manners of the M reference signal antenna ports in each of the N second resource grids are the same, and both N and M are positive integers. The transmit end outputs a reference signal based on the first resource grid.

Based on the foregoing technical solution, the transmit end and a receive end may exchange a reference signal on the first resource grid. The first resource grid includes N units, and each unit supports mapping the M different reference signal antenna ports. Therefore, more reference signal antenna ports can be supported, and more reference signal antenna ports can be mapped to contiguous first resource grids, thereby helping improve a capacity of the reference signal.

In addition, because the multiplexing manners of the M reference signal antenna ports in each second resource grid are the same, a port multiplexing capability is improved, so that a reference signal pattern with a small quantity of ports is a subset of a reference signal pattern with a large quantity of ports, to implement a nested structure. In this way, complexity and power consumption of a receiver can be reduced.

In an embodiment, a value of M is any one of the following: 4, 6, 8, 12, 16, and 24.

With reference to the first aspect, in some embodiments of the first aspect, the method further includes: The transmit end outputs or inputs first indication information. The first indication information indicates a value of N, or the first indication information indicates a total quantity Q of to-be-mapped reference signal antenna ports on the first resource grid, and Q is a positive integer.

In an embodiment, if the transmit end is located on the network side, the transmit end may output the first indication information to a terminal device. If the transmit end is located on the terminal side, the transmit end may input the first indication information from a network device, so that the terminal device may determine the first resource grid based on the first indication information. In this way, the network device and the terminal device may transmit the reference signal based on the first resource grid, thereby helping improve a capacity of the reference signal.

With reference to the first aspect, in some embodiments of the first aspect, the method further includes: The transmit end determines a precoding resource block group. The precoding resource block group includes X precoding resource blocks, the X precoding resource blocks correspond to X contiguous first resource grids, the first resource grid includes one of the X precoding resource blocks, each of the X precoding resource blocks is separated by N−1 second resource grids, and X is a positive integer.

Based on the foregoing solution, in this application, the precoding resource block group may be determined based on the first resource grid and the second resource grid, and the receive end may perform channel estimation by using the precoding resource block group. In this way, reliability of channel estimation and data demodulation at the receive end can be ensured.

With reference to the first aspect, in some embodiments of the first aspect, that the transmit end determines the precoding resource block group includes: The transmit end determines one precoding resource block every N−1 second resource grids. The transmit end determines the X precoding resource blocks. The X precoding resource blocks form the precoding resource block group, and X is greater than 1.

With reference to the first aspect, in some embodiments of the first aspect, the method further includes: The transmit end outputs or inputs second indication information, where the second indication information indicates a value of X.

In an embodiment, if the transmit end is located on the network side, the transmit end may output the second indication information to the terminal device. If the transmit end is located on the terminal side, the transmit end may input the second indication information from the network device, so that the terminal device may determine the precoding resource block group based on the second indication information. Further, when the terminal device performs channel estimation by using reference signals in the precoding resource block group together, accuracy of channel estimation can be improved.

With reference to the first aspect, in some embodiments of the first aspect, that the transmit end determines the precoding resource block group includes: The transmit end determines one precoding resource block in the first resource grid. The precoding resource block forms the precoding resource block group. That is, X is equal to 1.

With reference to the first aspect, in some embodiments of the first aspect, the method further includes: The transmit end performs rate matching on to-be-sent data based on the first resource grid.

In an embodiment, that the transmit end performs the rate matching on the to-be-sent data based on the first resource grid may mean that the transmit end determines a resource in the first resource grid to which the reference signal is mapped, and maps the to-be-sent data to another resource, to ensure that no conflict occurs between resources for the reference signal and the data.

In an embodiment, the transmit end performs the rate matching on the to-be-sent data based on the first resource grid includes: The transmit end maps the to-be-sent data on a first resource. The first resource is a resource other than resources occupied by M*N reference signal antenna ports on the first resource grid.

Based on the foregoing solution, a rate matching method may be determined based on N. When receiving data, the receive end does not need to determine an actual resource to which the reference signal is mapped, and directly receives the data on the resource other than the resources occupied by the M*N reference signal antenna ports. In this way, complexity of data demodulation at the receive end can be reduced.

In another embodiment, the transmit end performs the rate matching on the to-be-sent data based on the first resource grid includes: The transmit end maps the to-be-sent data on a second resource. The second resource is a resource other than resources occupied by Q reference signal antenna ports on the first resource grid, Q is the total quantity of the to-be-mapped reference signal antenna ports on the first resource grid, and Q is a positive integer.

Based on the foregoing solution, the rate matching method may be determined based on the total quantity Q of the to-be-mapped reference signal antenna ports. In this way, data can be mapped to positions other than an actual position of a time-frequency resource to which the reference signal is mapped, so that spatial domain or time-frequency domain resources can be fully utilized, and data transmission efficiency can be maximized.

In an embodiment, the reference signal is a demodulation reference signal (demodulation reference signal, DMRS).

According to a second aspect, a communication method is provided. The method may be performed by a receive end. The receive end may be a communication device, or may be a component (such as a chip or a chip system) used for a communication device. This is not limited in this application. The following uses an example in which the method is performed by the receive end. The receive end is a receive end of a reference signal and data, and may be located on a terminal side, or may be located on a network side.

The method includes: The receive end determines a first resource grid. The first resource grid includes N second resource grids, the second resource grid supports mapping M different reference signal antenna ports, multiplexing manners of the M reference signal antenna ports in each of the N second resource grids are the same, and both N and M are positive integers. The receive end inputs a reference signal based on the first resource grid.

Based on the foregoing technical solution, a transmit end and the receive end may exchange a reference signal on the first resource grid. The first resource grid includes N units, and each unit supports mapping the M different reference signal antenna ports. Therefore, more reference signal antenna ports can be supported, and more reference signal antenna ports can be mapped to contiguous first resource grids, thereby helping improve a capacity of the reference signal.

In an embodiment, a value of M is any one of the following: 4, 6, 8, 12, 16, and 24.

With reference to the second aspect, in some embodiments of the second aspect, the method further includes: The receive end inputs or outputs first indication information. The first indication information indicates a value of N, or the first indication information indicates a total quantity Q of to-be-mapped reference signal antenna ports on the first resource grid, and Q is a positive integer.

With reference to the second aspect, in some embodiments of the second aspect, the method further includes: The receive end determines a resource bundling of resource blocks which may be referred to as a precoding resource block group. The precoding resource block group includes X precoding resource blocks, the X precoding resource blocks correspond to X contiguous first resource grids, the first resource grid includes one of the X precoding resource blocks, each of the X precoding resource blocks is separated by N−1 second resource grids, and X is a positive integer.

With reference to the second aspect, in some embodiments of the second aspect, that the receive end determines the precoding resource block group includes: The receive end determines one precoding resource block every N−1 second resource grids. The receive end determines the X precoding resource blocks. The X precoding resource blocks form the precoding resource block group, and X is greater than 1.

With reference to the second aspect, in some embodiments of the second aspect, the method further includes: The receive end outputs or inputs second indication information. The second indication information indicates a value of X.

With reference to the second aspect, in some embodiments of the second aspect, that the receive end determines the precoding resource block group includes: The receive end determines one precoding resource block in the first resource grid. The precoding resource block forms the precoding resource block group. That is, X is equal to 1.

With reference to the second aspect, in some embodiments of the second aspect, the method further includes: The receive end determines, based on the first resource grid, a resource to which to-be-received data is mapped.

In an embodiment, that the receive end determines, based on the first resource grid, the resource to which the to-be-received data is mapped includes: The receive end determines that the to-be-received data is mapped to a first resource. The first resource is a resource other than resources occupied by M*N reference signal antenna ports on the first resource grid.

In another embodiment, that the receive end determines, based on the first resource grid, the resource to which the to-be-received data is mapped includes: The receive end determines that the to-be-received data is mapped to a second resource. The second resource is a resource other than resources occupied by Q reference signal antenna ports on the first resource grid, Q is the total quantity of the to-be-mapped reference signal antenna ports on the first resource grid, and Q is a positive integer.

In an embodiment, the reference signal is a DMRS.

According to a third aspect, a communication apparatus is provided. The apparatus may be a communication device, or may be a component (for example, a chip or a chip system) used in a communication device. This is not limited in this application.

The apparatus includes: a processing unit, configured to determine a first resource grid, where the first resource grid includes N second resource grids, the second resource grid supports mapping M different reference signal antenna ports, multiplexing manners of the M reference signal antenna ports in each of the N second resource grids are the same, and both N and M are positive integers; and a transceiver unit, configured to output a reference signal based on the first resource grid.

In an embodiment, a value of M is any one of the following: 4, 6, 8, 12, 16, and 24.

With reference to the third aspect, in some embodiments of the third aspect, the transceiver unit is further configured to output or input first indication information. The first indication information indicates a value of N, or the first indication information indicates a total quantity Q of to-be-mapped reference signal antenna ports on the first resource grid, and Q is a positive integer.

With reference to the third aspect, in some embodiments of the third aspect, the processing unit is further configured to determine a precoding resource block group. The precoding resource block group includes X precoding resource blocks, the X precoding resource blocks correspond to X contiguous first resource grids, the first resource grid includes one of the X precoding resource blocks, each of the X precoding resource blocks is separated by N−1 second resource grids, and X is a positive integer.

With reference to the third aspect, in some embodiments of the third aspect, the processing unit is configured to: determine one precoding resource block every N−1 second resource grids; and determine the X precoding resource blocks. The X precoding resource blocks form the precoding resource block group, and X is greater than 1.

With reference to the third aspect, in some embodiments of the third aspect, the transceiver unit is further configured to output or input second indication information. The second indication information indicates a value of X.

With reference to the third aspect, in some embodiments of the third aspect, the processing unit is configured to determine one precoding resource block in the first resource grid. The precoding resource block forms the precoding resource block group. That is, X is equal to 1.

With reference to the third aspect, in some embodiments of the third aspect, the processing unit is further configured to perform rate matching on to-be-sent data based on the first resource grid.

In an embodiment, the processing unit is configured to map the to-be-sent data to a first resource. The first resource is a resource other than resources occupied by M*N reference signal antenna ports on the first resource grid.

In another embodiment, the processing unit is configured to map the to-be-sent data on a second resource. The second resource is a resource other than resources occupied by Q reference signal antenna ports on the first resource grid, Q is the total quantity of the to-be-mapped reference signal antenna ports on the first resource grid, and Q is a positive integer.

In an embodiment, the reference signal is a DMRS.

According to a fourth aspect, a communication apparatus is provided. The apparatus may be a communication device, or may be a component (for example, a chip or a chip system) used in a communication device. This is not limited in this application.

The apparatus includes: a processing unit, configured to determine a first resource grid, where the first resource grid includes N second resource grids, the second resource grid supports mapping M different reference signal antenna ports, multiplexing manners of the M reference signal antenna ports in each of the N second resource grids are the same, and both N and M are positive integers; and a transceiver unit, configured to input a reference signal based on the first resource grid.

In an embodiment, a value of M is any one of the following: 4, 6, 8, 12, 16, and 24.

With reference to the fourth aspect, in some embodiments of the fourth aspect, the transceiver unit is further configured to input or output first indication information. The first indication information indicates a value of N, or the first indication information indicates a total quantity Q of to-be-mapped reference signal antenna ports on the first resource grid, and Q is a positive integer.

With reference to the fourth aspect, in some embodiments of the fourth aspect, the processing unit is further configured to determine a resource bundling which may include a precoding resource block group. The precoding resource block group includes X precoding resource blocks, the X precoding resource blocks correspond to X contiguous first resource grids, the first resource grid includes one of the X precoding resource blocks, each of the X precoding resource blocks is separated by N−1 second resource grids, and X is a positive integer.

With reference to the fourth aspect, in some embodiments of the fourth aspect, the processing unit is configured to: determine one precoding resource block every N−1 second resource grids; and determine the X precoding resource blocks. The X precoding resource blocks form the precoding resource block group, and X is greater than 1.

With reference to the fourth aspect, in some embodiments of the fourth aspect, the transceiver unit is further configured to output or input second indication information. The second indication information indicates a value of X.

With reference to the fourth aspect, in some embodiments of the fourth aspect, the processing unit is configured to determine one precoding resource block in the first resource grid. The precoding resource block forms the precoding resource block group. That is, X is equal to 1.

With reference to the fourth aspect, in some embodiments of the fourth aspect, the processing unit is further configured to determine, based on the first resource grid, the resource to which the to-be-received data is mapped.

In an embodiment, the processing unit is configured to determine that the to-be-received data is mapped to a first resource. The first resource is a resource other than resources occupied by M*N reference signal antenna ports on the first resource grid.

In another embodiment, the processing unit is configured to determine that the to-be-received data is mapped to a second resource. The second resource is a resource other than resources occupied by Q reference signal antenna ports on the first resource grid, Q is the total quantity of the to-be-mapped reference signal antenna ports on the first resource grid, and Q is a positive integer.

In an embodiment, the reference signal is a DMRS.

It should be understood that, for beneficial effects of the second aspect to the fourth aspect, refer to related descriptions of the first aspect. Details are not described herein again.

According to a fifth aspect, a communication apparatus is provided. The apparatus is configured to perform the method according to either of the first aspect and the second aspect. In an embodiment, the apparatus may include a unit and/or a module configured to perform the method according to any one of the foregoing embodiments of either of the first aspect and the second aspect, for example, a processing unit and/or a communication unit.

For the third aspect, the fourth aspect, or the fifth aspect, in an embodiment, the apparatus is a communication device. When the apparatus is a communication device, a communication unit may be a transceiver or an input/output interface, and the processing unit may be at least one processor. In an embodiment, the transceiver may be a transceiver circuit. In an embodiment, the input/output interface may be an input/output circuit.

In another embodiment, the apparatus is a chip, a chip system, or a circuit used in a communication device. When the apparatus is the chip, the chip system, or the circuit used in the communication device, the communication unit may be an input/output interface, an interface circuit, an output circuit, an input circuit, a pin, a related circuit, or the like on the chip, the chip system, or the circuit, and the processing unit may be at least one processor, a processing circuit, a logic circuit, or the like.

According to a sixth aspect, a communication apparatus is provided. The apparatus includes: a memory, configured to store a program; and at least one processor, configured to execute a computer program or instructions stored in the memory, to perform the method according to any one of the embodiments of either of the first aspect and the second aspect.

In an embodiment, the apparatus is a communication device.

In another embodiment, the apparatus is a chip, a chip system, or a circuit used in a communication device.

According to a seventh aspect, this application provides a processor. The processor is configured to perform the methods provided in the foregoing aspects.

Operations such as sending and obtaining/receiving related to the processor may be understood as operations such as output and input of the processor, or sending and receiving operations performed by a radio frequency circuit and an antenna, unless otherwise specified, or provided that the operations do not contradict actual functions or internal logic of the operations in related descriptions. This is not limited in this application.

According to an eighth aspect, a computer-readable storage medium is provided. The computer-readable medium stores program code to be executed by a device, and the program code is used to perform the method according to any one of the embodiments of either of the first aspect and the second aspect.

According to a ninth aspect, a computer program product including instructions is provided. When the computer program product is run on a computer, the computer is enabled to perform the method according to any one of the embodiments of either of the first aspect and the second aspect.

According to a tenth aspect, a chip is provided. The chip includes a processor and a communication interface. The processor reads, through the communication interface, instructions stored in a memory, to perform the method according to any one of the embodiments of either of the first aspect and the second aspect.

In an embodiment, the chip further includes the memory. The memory stores a computer program or the instructions. The processor is configured to execute the computer program or the instructions stored in the memory. When the computer program or the instructions are executed, the processor is configured to perform the method according to any one of the embodiments of either of the first aspect and the second aspect.

### BRIEF DESCRIPTION OF DRAWINGS

FIG. 1 is a diagram of a wireless communication system 100 applicable to an embodiment of this application;

FIG. 2 shows DMRS patterns of two configuration types;

FIG. 3 shows DMRS patterns corresponding to several other DMRS configuration types;

FIG. 4 shows another DMRS pattern;

FIG. 5 is a schematic flowchart of a communication method 200 according to an embodiment of this application;

FIG. 6 shows a mapping pattern of a reference signal according to this application;

FIG. 7 is a diagram of a precoding resource block group according to this application;

FIG. 8 is a schematic flowchart of a communication method 300 according to an embodiment of this application;

FIG. 9 is a diagram of spectral efficiency according to an embodiment of this application;

FIG. 10 is a block diagram of a communication apparatus 1000 according to an embodiment of this application;

FIG. 11 is a block diagram of a communication apparatus 1100 according to an embodiment of this application; and

FIG. 12 is a block diagram of a chip system 1200 according to an embodiment of this application.

### DESCRIPTION OF EMBODIMENTS

Technical solutions of this application are described below with reference to the accompanying drawings.

The technical solutions provided in this application may be applied to various communication systems, for example, a 5th generation (5G) or new radio (NR) system, a long term evolution (LTE) system, an LTE frequency division duplex (FDD) system, and an LTE time division duplex (TDD) system. The technical solutions provided in this application may be further applied to a future communication system, for example, a 6th generation (6G) mobile communication system. The technical solutions provided in this application may be further applied to device-to-device (D2D) communication, vehicle-to-everything (V2X) communication, machine-to-machine (M2M) communication, machine type communication (MTC), an internet of things (IoT) communication system, or another communication system. This is not limited in this application.

In embodiments of this application, a network device may be any device having a wireless transceiver function. The device includes, but is not limited to: an evolved NodeB (eNB), a radio network controller (RNC), a NodeB (NB), a base station controller (BSC), a base transceiver station (BTS), a home base station (for example, a home evolved NodeB, a home NodeB, or an HNB), a baseband unit (BBU), an access point (AP) in a wireless fidelity (Wi-Fi) system, a wireless relay node, a wireless backhaul node, a transmission point (TP), a transmission and reception point (TRP), or the like. Alternatively, the device may be a gNB or a transmission point (TRP or TP) in a 5G system, for example, an NR system, one or one group (including a plurality of antenna panels) of antenna panels of a base station in a 5G system; or may be a network node constructing a gNB or a transmission point, for example, a baseband unit (BBU) or a distributed unit (distributed unit, DU), or a base station in a next generation 6G communication system.

In some deployments, the gNB may include a central unit (CU) and a DU. The gNB may further include an active antenna unit (AAU). The CU implements some functions of the gNB, and the DU implements some functions of the gNB. For example, the CU is responsible for processing a non-real-time protocol and a service, and implements functions of a radio resource control (RRC) layer and a packet data convergence protocol (PDCP) layer. The DU is responsible for processing a physical layer protocol and a real-time service, and implements functions of a radio link control (RLC) layer, a medium access control (MAC) layer, and a physical (PHY) layer. The AAU implements some physical layer processing functions, radio frequency processing, and a function related to an active antenna. Information at the RRC layer is eventually converted into information at the PHY layer, or is converted from information at the PHY layer. Therefore, in this architecture, higher layer signaling such as RRC layer signaling may also be considered as being sent by the DU or sent by the DU and the AAU. It may be understood that the network device may be a device including one or more of a CU node, a DU node, and an AAU node. In addition, the CU may be classified into a network device in an access network (RAN), or the CU may be classified into a network device in a core network (CN). This is not limited in this application.

The network device provides a service for a cell, and the terminal device uses a transmission resource (for example, a frequency domain resource or a spectrum resource) allocated by the network device to communicate with the cell. The cell may belong to a macro base station (for example, a macro eNB or a macro gNB), or may belong to a base station corresponding to a small cell (small cell). The small cell herein may include a metro cell (metro cell), a micro cell (micro cell), a pico cell (pico cell), a femto cell (femto cell), or the like. These small cells have features of small coverage and low transmit power, and are applicable to providing a high-speed data transmission service.

In embodiments of this application, the terminal device may also be referred to as a user equipment (user equipment, UE), an access terminal, a subscriber unit, a subscriber station, a mobile station, a mobile console, a remote station, a remote terminal, a mobile device, a user terminal, a terminal, a wireless communication device, a user agent, or a user apparatus.

The terminal device may be a device that provides voice/data connectivity for a user, for example, a handheld device or a vehicle-mounted device that has a wireless connection function. Currently, some examples of the terminal may be: a mobile phone (mobile phone), a tablet computer (pad), a computer (for example, a notebook computer or a palmtop computer) having a wireless transceiver function, a mobile internet device (MID), a virtual reality (VR) device, an augmented reality (AR) device, a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a cellular phone, a cordless telephone set, a session initiation protocol (SIP) phone, a wireless local loop (WLL) station, a personal digital assistant (PDA), a handheld device having a wireless communication function, a computing device, another processing device connected to a wireless modem, a vehicle-mounted device, a wearable device, a terminal device in a 5G network, or a terminal device in a future evolved public land mobile network (PLMN).

The wearable device may also be referred to as a wearable intelligent device, and is a general term of wearable devices, such as glasses, gloves, watches, clothes, and shoes, that are developed and intelligently designed for daily wear by using a wearable technology. The wearable device is a portable device that is worn on a body directly or integrated into clothes or an accessory of a user. The wearable device is not only a hardware device, but also implements a powerful function through software support, data exchange, and cloud interaction. In a broad sense, wearable intelligent devices include full-featured and large-sized devices that can implement complete or partial functions without depending on smartphones, for example, smart watches or smart glasses, and devices that focus on only one type of application function and need to work with other devices such as smartphones, for example, various smart bands or smart jewelry for monitoring physical signs.

In addition, the terminal device may alternatively be a terminal device in an internet of things (IoT) system. The IoT is an important part in future development of information technologies. A main technical feature of the IoT is to connect things to a network by using a communication technology, to implement an intelligent network for human-machine interconnection and thing-thing interconnection. An IoT technology may implement massive connections, deep coverage, and terminal power saving by using, for example, a narrowband (NB) technology.

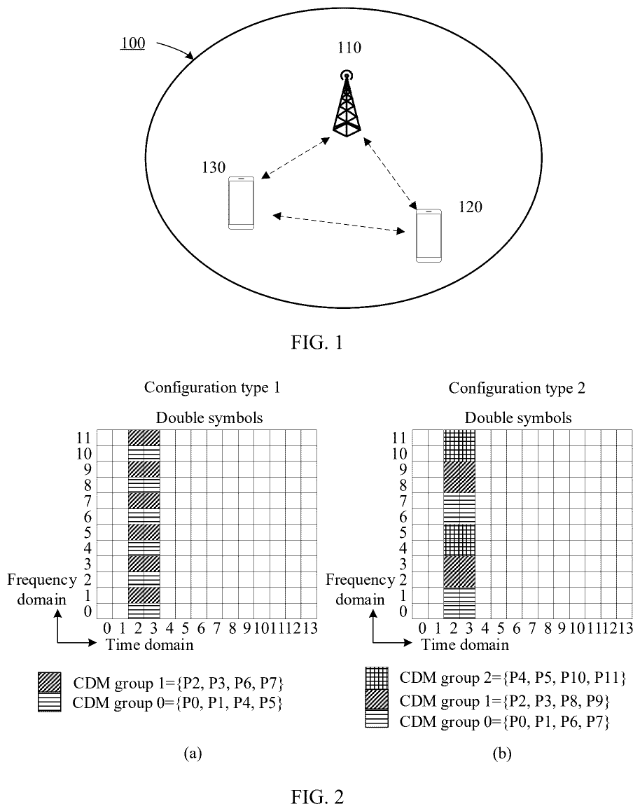

In an example, FIG. 1 is a diagram of a wireless communication system 100 applicable to an embodiment of this application. As shown in FIG. 1, the wireless communication system 100 may include at least one network device, for example, a network device 110 shown in FIG. 1. The wireless communication system 100 may further include at least one terminal device, for example, a terminal device 120 and a terminal device 130 shown in FIG. 1. A plurality of antennas may be configured for both the network device and the terminal device, and the network device and the terminal device may communicate with each other by using a multi-antenna technology. The terminal devices may directly communicate with each other.

When the network device communicates with the terminal device, the network device may manage at least one cell, and there may be at least one terminal device in one cell. In an embodiment, the network device 110 and the terminal device 120 form a single-cell communication system. Without loss of generality, the cell is referred to as a cell #1. The network device 110 may be a network device in the cell #1, or the network device 110 may serve a terminal device (for example, the terminal device 120) in the cell #1.

It should be noted that the cell may be understood as an area within a coverage area of a radio signal of the network device.

It should be understood that FIG. 1 is merely a simplified diagram of an example for ease of understanding. The wireless communication system 100 may further include another network device or may further include another terminal device, which is not shown in FIG. 1. Embodiments of this application are applicable to any communication scenario in which the network device communicates with the terminal device. For example, the method may be applied to downlink communication, and may also be applied to uplink communication. In downlink communication, the network device serves as a transmit end, the terminal device serves as a receive end, and the network device may send a downlink reference signal and downlink data to the terminal device. In uplink communication, the terminal device serves as a transmit end, the network device serves as a receive end, and the terminal device may send an uplink reference signal and uplink data to the network device.

For ease of understanding of embodiments of this application, terms in embodiments of this application are briefly described below.

### 1. Multiple-Input Multiple-Output (MIMO) Technology

In the MIMO technology, an array gain, multiplexing and diversity gains, and a co-channel interference reduction gain in space can be obtained for a signal by using a resource in a space dimension without increasing a system bandwidth, so that a capacity and spectral efficiency of a communication system are exponentially improved. For example, in an LTE system, the system may use a plurality of antennas at a transmit end and a receive end to support transmission of up to eight layers, thereby effectively improving a system capacity.

### 2. Time-Frequency Resource

In embodiments of this application, data or information may be carried by using a time-frequency resource. The time-frequency resource may include a time domain resource and a frequency domain resource. In time domain, the time-frequency resource may include one or more time domain units (which may also be referred to as time units or time elements). In frequency domain, the time-frequency resource may include one or more frequency domain units.

One time domain unit may be one symbol or several symbols (for example, an orthogonal frequency division multiplexing (orthogonal frequency division multiplexing, OFDM) symbol), one slot (slot), one mini-slot (mini-slot), or one subframe (subframe). One slot may include seven or 14 symbols. One mini-slot may include at least one symbol (for example, two symbols, seven symbols, or 14 symbols, or any quantity of symbols less than or equal to 14 symbols). Duration of one subframe in time domain may be 1 millisecond (ms). It should be understood that sizes of the foregoing listed time domain units are only used for ease of understanding of the solutions in this application, and do not constitute a limitation on the protection scope of this application. It may be understood that the sizes of the foregoing time-domain units may be other values. This is not limited in this application.

A frequency domain unit may be a resource block (RB), a subcarrier (subcarrier), a resource block group (RBG), a predefined subband (subband), a precoding resource block group (PRG), a bandwidth part (BWP), a resource element (RE) (which may also be referred to as a resource unit or a resource element), a carrier, or a serving cell.

### 3. Reference Signal (RS)

The reference signal may also be referred to as a pilot, a reference sequence, a reference signal, or the like. In this application, the reference signal may be a reference signal used for channel measurement and channel estimation. Reference signals are distributed on different REs in a time-frequency two-dimensional space in an OFDM symbol, and have known amplitudes and phases. In a MIMO system, each transmit antenna (a virtual antenna or a physical antenna) has an independent data channel. A receiver performs channel estimation for each transmit antenna based on a known RS signal, and restores transmit data based on the channel estimation. Currently, a plurality of reference signals have been defined in a standard, for example, a cell-specific reference signal (CRS), a demodulation reference signal (DMRS), a channel state information reference symbol (CSI-RS), and a sounding reference signal (SRS). The DMRS is used to estimate an equivalent channel matrix of a data channel (for example, a physical uplink shared channel (PUSCH) or a physical downlink shared channel (PDSCH)) or a control channel (for example, a physical uplink shared channel (PUCCH) or a physical downlink shared channel (PDCCH)), to be used for data detection and demodulation on a corresponding channel. The CSI-RS is used to measure channel information and report information such as a channel quality indicator (CQI), a precoding matrix indicator (PMI), and a rank indicator (RI). The SRS is used to measure an uplink channel, and may estimate a downlink channel based on the uplink channel, so that a precoding matrix used for downlink transmission may be determined.

It should be understood that the foregoing listed reference signals are merely examples, and should not constitute any limitation on this application. This application does not exclude a possibility of defining another reference signal in a future protocol to implement a same or similar function.

### 4. Antenna Port

The antenna port is referred to as a port for short, and may include a transmit port (or referred to as a transmission port) and a receive port. The transmit port may be understood as a virtual antenna identified by a receiving device, a transmit antenna identified by a receive end, or a transmit antenna that can be distinguished in space. The transmit port may also be referred to as a port of a precoding reference signal. A reference signal of each transmit port may be transmitted by using one or more frequency domain units. One antenna port may be configured for each virtual antenna, and each virtual antenna may be a weighted combination of a plurality of physical antennas. The receive port may be understood as a receive antenna of the receiving device. For example, in downlink transmission, the receive port may be a receive antenna of the terminal device.

Based on different carried signals, the antenna port may be classified into a reference signal antenna port (or referred to as a reference signal port or a pilot port) and a data antenna port (data port for short). For example, the reference signal port includes but is not limited to a DMRS port and a CSI-RS port.

### 5. Precoding Resource Block Group (PRG)

Resources using same precoding may be referred to as a PRG, or referred to as a PRB bundling (PRB bundling). A granularity of the PRG may also be referred to as a granularity of the PRB bundling. The granularity of the PRG may be a PRB, or may be a resource of another granularity. This is not limited. For example, if the granularity of the PRG is a PRB, a plurality of PRBs in frequency domain may use same precoding. In this way, the receive end may perform channel estimation by using the plurality of PRBs together, thereby improving accuracy of channel estimation. In this case, one PRG may include the foregoing plurality of PRBs. Currently, it is specified in NR that one or more contiguous PRBs are regarded as a PRB bundling or a PRG, and a quantity of contiguous PRBs may be {2, 4, a contiguous scheduled bandwidth}.

### 6. Rate Matching (Rate Matching)

To avoid mutual interference between a reference signal and data from affecting channel estimation performance and data demodulation performance, a position to which the reference signal is mapped needs to be avoided when the transmit end performs data mapping, to ensure that the data and the reference signal are mapped to different time-frequency resources. 5G NR indicates rate matching by specifying a maximum quantity of code division multiplexing (CDM) groups occupied by a DMRS in a current scheduling period. The receiver determines, by using information about the maximum quantity of CDM groups, a position to which the reference signal is mapped, and then performs data receiving and demodulation at another position.

A MIMO technology is one of the key technologies in 5G communication and future communication. When data is transmitted by using the MIMO technology, a receive end device may perform channel estimation based on a received reference signal (for example, a DMRS). The following uses the DMRS as an example to describe a quantity of reference signal ports currently supported by a protocol.

In the 3rd generation partnership project (3GPP) release (R) 15, up to 12 DMRS ports are supported, and overheads of a front-loaded DMRS is the same as those in LTE, which includes 24 REs for each RB pair.

FIG. 2 shows DMRS patterns of two configuration types in one RB in R15. Refer to (a) in FIG. 2. For a double-symbol DMRS of a configuration type 1, a comb-like and cyclic shift multiplexing manner is used, and a maximum of eight DMRS orthogonal ports, namely, P0, P1, P2, P3, P4, P5, P6, and P7, are supported. Refer to (b) in FIG. 2. For a double-symbol DMRS of a configuration type 2, a manner of frequency division multiplexing and time-frequency domain code division multiplexing is used, and a maximum of 12 DMRS orthogonal ports, namely, P0, P1, P2, P3, P4, P5, P6, P7, P8, P9, P10, and P11, are supported. REs of different filling patterns in FIG. 2 represent different code division multiplexing (code division multiplexing, CDM) groups (groups). In (a) in FIG. 2, eight DMRS ports belong to two CDM groups (that is, a CDM group 0 and a CDM group 1). The CDM group 0 includes P0, P1, P4, and P5. The CDM group 1 includes P2, P3, P6, and P7. In (b) in FIG. 2, 12 DMRS ports belong to three CDM groups (a CDM group 0, a CDM group 1, and a CDM group 2). The CDM group 0 includes P0, P1, P6, and P7. The CDM group 1 includes P2, P3, P8, and P9. The CDM group 2 includes P4, P5, P10, and P11.

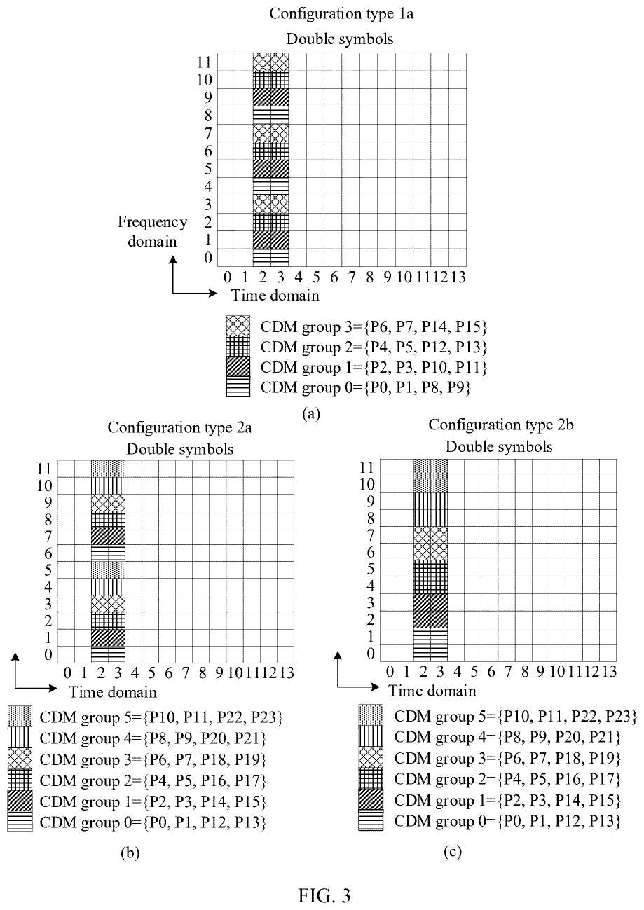

To meet increasing data throughput requirements, in the 3GPP R18, the industry proposes a DMRS with up to 24 ports to support simultaneous transmission of more data streams. Frequency domain sparsification is a typical method in R18. The following provides descriptions with reference to FIG. 3.

FIG. 3 shows DMRS patterns corresponding to DMRS configuration types newly added in R18. The DMRS configuration types are respectively denoted as a DMRS configuration type 1a, a DMRS configuration type 2a, and a DMRS configuration type 2b.

In an embodiment, sparsification design may be performed on both the CDM group 0 and the CDM group 1 in the double-symbol DMRS configuration type 1 shown in (a) in FIG. 2, to obtain the DMRS configuration type 1a. A DMRS pattern of the DMRS configuration type 1a is shown in (a) in FIG. 3. Sparsification design is performed on the CDM group 0 to the CDM group 2 in the double-symbol DMRS configuration type 2 shown in (b) in FIG. 2, to obtain the DMRS configuration type 2a or 2b. DMRS patterns of DMRS configuration types 2a and 2b are shown in (b) and (c) of FIG. 3. A difference between the DMRS configuration type 2a and the DMRS configuration type 2b lies in whether same CDM groups are contiguous in frequency domain.

A sparsification design process is described by using (a) in FIG. 2 and (a) in FIG. 3 as an example. In an embodiment, some subcarriers occupied by the CDM group 0 shown in (a) in FIG. 2 are frequency-division multiplexed for two newly added DMRS ports (for example, P4 and P5 in (a) in FIG. 3), and some subcarriers occupied by the CDM group 1 shown in (a) in FIG. 2 are frequency-division multiplexed for two newly added DMRS ports (for example, P6 and P7 in (a) in FIG. 3). In other words, time-frequency resources of the CDM group 0 shown in (a) in FIG. 2 are divided into two groups (for example, divided into a CDM group 0 and a CDM group 2 in (a) in FIG. 3), and time-frequency resources of the CDM group 1 shown in (a) in FIG. 2 are divided into two groups (for example, divided into a CDM group 1 and a CDM group 3 in (a) in FIG. 3).

As shown in (a) in FIG. 3, when the DMRS configuration type is the DMRS configuration type 1a, a DMRS pattern supports a maximum of 16 DMRS ports (P0 to P15). The 16 DMRS ports correspond to four CDM groups (the CDM group 0, the CDM group 1, the CDM group 2, and the CDM group 3).

Similarly, as shown in (b) in FIG. 3, when the DMRS configuration type is the DMRS configuration types 2a and 2b, a DMRS pattern supports a maximum of 24 DMRS ports. The 24 DMRS ports correspond to six CDM groups.

It should be understood that FIG. 2 and FIG. 3 show double-symbol DMRS patterns, and a single-symbol DMRS pattern is similar. For example, a single-symbol DMRS configuration type 1 supports a maximum of four DMRS orthogonal ports, namely, P0, P1, P2, and P3 shown in (a) in FIG. 2. A single-symbol DMRS configuration type 1a supports a maximum of eight DMRS orthogonal ports, namely, P0, P1, P2, P3, P4, P5, P6, and P7 shown in (a) in FIG. 3. A single-symbol DMRS configuration type 2 supports a maximum of six DMRS orthogonal ports, namely, P0, P1, P2, P3, P4, and P5 shown in (b) in FIG. 2. Single-symbol DMRS configuration types 2a and 2b support a maximum of 12 DMRS orthogonal ports, namely, P0, P1, P2, P3, P4, P5, P6, P7, P8, P9, P10, and P11 shown in (b) and (c) in FIG. 3. Therefore, through comparison between FIG. 2 and FIG. 3, it can be learned that a density of DMRSs in R18 is reduced to ½ of an original density.

It should be understood that, in this application, a density of reference signals is a density of time-frequency resources occupied by the reference signals, that is, a density of time-frequency resources (for example, REs) carrying the reference signals in a time-frequency resource group (for example, an RB). In other words, the “density” may be a proportion of time-frequency resources used to carry a reference signal in a time-frequency resource group to time-frequency resources in the time-frequency resource group.

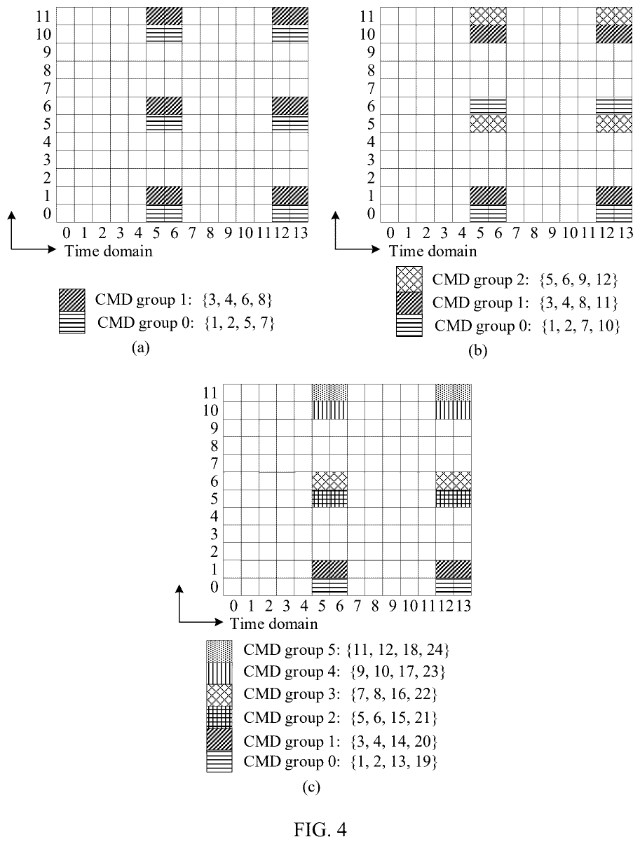

FIG. 4 shows another DMRS configuration pattern. The DMRS configuration pattern shown in FIG. 4 may be understood as a hierarchical DMRS design or a segmented DMRS design. In an embodiment, different patterns and densities are used to meet various levels of multiplexing requirements.

As shown in (a) in FIG. 4, a maximum total quantity of ports that can be supported by the DMRS pattern is 8. In this case, the DMRS pattern uses a high density. In an embodiment, a same DMRS port occupies three subcarriers on each PRB (three subcarriers/PRB per port) in frequency domain. As shown in (b) in FIG. 4, a maximum total quantity of ports that can be supported by the DMRS pattern is 12. In this case, the DMRS pattern uses a medium density. In an embodiment, for each port, a same DMRS port occupies two subcarriers on each PRB (two subcarriers/PRB per port) in frequency domain. As shown in (c) in FIG. 4, a maximum total quantity of ports that can be supported by the DMRS pattern is 24. In this case, the DMRS pattern uses a low density. A same DMRS port occupies one subcarrier on each PRB (one subcarrier/PRB per port) in frequency domain.

In the DMRS configuration solution shown in FIG. 4, the DMRS supports a maximum of 24 orthogonal ports, that is, a maximum of 24 orthogonal data streams can be simultaneously transmitted. This manner can ensure better demodulation performance. However, because of an unnested (Unnested) structure (that is, a DMRS pattern with a small quantity of ports is not a subset of a DMRS pattern with a large quantity of ports), a corresponding channel estimation solution needs to be designed for DMRSs at different orders. As a result, an indication manner and a receiver algorithm become complex.

It can be learned from FIG. 2 to FIG. 4 that, currently, a reference signal supports a maximum of 24 orthogonal ports, that is, simultaneous transmission of a maximum of 24 orthogonal data streams can be implemented. However, in an enhanced mobile broadband (enhanced mobile broadband, eMBB) scenario, spectral efficiency of data transmission of 24 ports is far from satisfying transmission of higher-order (more data streams) data streams in a larger antenna dimension. For example, hundreds or thousands of data streams are simultaneously transmitted. In addition, after the reference signal pattern is determined, a quantity of ports that can be supported is fixed, which is not flexible enough.

In view of this, this application provides a communication method and a communication apparatus. In this way, more reference signal ports can be supported. In addition, a quantity of reference signal ports can be flexibly configured.

It should be understood that the reference signal in this application may be any reference signal that can be used for channel estimation, for example, a DMRS, a CRS, an SRS, or another reference signal that can be used to implement a same or similar function. In a communication system that may appear in the future, a name of the reference signal may change. However, the technical solutions of this application are applicable provided that a function of the reference signal is still for channel estimation at the receive end.

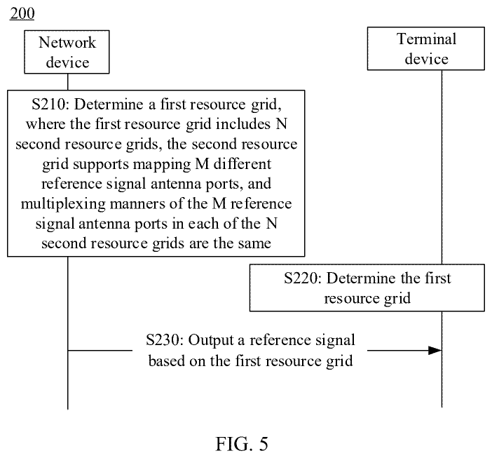

FIG. 5 is a schematic flowchart of a communication method 200 according to an embodiment of this application. As shown in FIG. 5, the method 200 includes the following operations. It should be understood that the method 200 uses downlink as an example. In the downlink, for example, the transmit end is a network device, the receive end is a terminal device, and the reference signal is a downlink reference signal, for example, a DMRS or a CRS.

S210: The network device (the transmit end) determines a first resource grid (resource grid), where the first resource grid includes N second resource grids.

The second resource grid supports mapping M different reference signal antenna ports, multiplexing manners of the M reference signal antenna ports in each of the N second resource grids are the same, and both N and M are positive integers. The multiplexing manner (or multiplexing scheme) is a specific manner of multiplexing between ports such as defined a set of rules, operations, or algorithms that define how signals (e.g., a reference signal) and/or a ports are assigned to available time and/or frequency resources, and may include at least one of time division multiplexing (time division multiplexing, TDM), frequency division multiplexing (frequency division multiplexing, FDM), and code division multiplexing (code division multiplexing, CDM).

In an embodiment, the second resource grid may be understood as a minimum mapping unit in the first resource grid. The second resource grid may also be referred to as a resource grid unit, a component, a mapping unit, a basic unit, a reference signal pattern of a smallest granularity, or the like. The second resource grid supports mapping M different reference signal antenna ports. In other words, a maximum quantity of reference signal ports that can be mapped by the second resource grid is M. In this application, the second resource grid not only includes a time-frequency resource, but also includes an arrangement manner of ports on the time-frequency resource and a multiplexing manner between ports.

The first resource grid includes N second resource grids. In other words, the first resource grid includes N second resource grid units. In other words, N units may be found in the first resource grid, and a mapping manner of each unit is the same. That is, each of the N second resource grids has a same mapping manner. The mapping manner is a manner in which each port is mapped to the time-frequency resource, or a manner in which a port is arranged on the time-frequency resource. Therefore, the first resource grid may support mapping N*M different reference signal antenna ports. That is, a total quantity of reference signal ports that can be mapped by the first resource grid is N*M.

In an embodiment, the N second resource grids are contiguous in frequency domain or contiguous in time domain.

It should be understood that in the following descriptions in this application, “multiplexing manners of the M reference signal antenna ports in each of the N second resource grids are the same” and “each of the N second resource grids has a same mapping manner” are described by using an example in which each of the N second resource grids is completely mapped. However, this application does not impose a limitation on each of the N second resource grids being completely mapped. In a case of incomplete mapping, the foregoing descriptions may be replaced with: “There are N−1 second resource grids in the N second resource grids, and multiplexing manners of the M reference signal antenna ports in each of the N−1 second resource grids are the same” or “There are N−1 second resource grids in the N second resource grids, and each of the N−1 second resource grids has a same mapping manner”. Similarly, the foregoing description “the second resource grid supports mapping M different reference signal antenna ports” means that a maximum value of reference signal antenna ports that are allowed to be mapped to the second resource grid is M. An example in which complete mapping is performed on the second resource grid is used for description. However, this application does not impose a limitation on each of the N second resource grids being completely mapped. In a case of incomplete mapping, there may be at least one second resource grid in the N second resource grids that only maps some of the M different reference signal antenna ports. In this application, unless otherwise specified, descriptions such as “multiplexing manners of the M reference signal antenna ports in each of the N second resource grids are the same”, “each of the N second resource grids has a same mapping manner”, and “the second resource grid supports mapping M different reference signal antenna ports” all refer to a case of complete mapping.

It should be further understood that the second resource grid may be used for mapping a data antenna port in addition to the reference signal antenna port. For example, on the second resource grid, all remaining resources except a reference signal antenna port resource may be used for mapping a data port.

In addition, the second resource grid may correspond to several contiguous subcarriers in frequency domain and several contiguous symbols in time domain. A time-frequency resource corresponding to the second resource grid is not limited in this application. A position corresponding to the second resource grid in time domain may include only a time domain resource to which the reference signal can be mapped (in other words, the second resource grid includes only resources occupied by the M reference signal antenna ports), or may include a time-frequency resource to which the reference signal is mapped and a resource to which data is mapped. In an example, the second resource grid may correspond to one PRB (for example, 12 subcarriers) in frequency domain and one slot (for example, 14 symbols) in time domain. In another example, the second resource grid may correspond to one PRB (for example, 12 subcarriers) in frequency domain and two symbols in time domain. For example, the second resource grid may be resources occupied by the M reference signal antenna ports.

Similarly, the time-frequency resource corresponding to the first resource grid is not limited in this application. For example, if the N second resource grids are contiguous in frequency domain, the first resource grid may be several PRBs in frequency domain and one slot or two symbols in time domain.

In an embodiment, a reference signal pattern (pattern) of the second resource grid may be specified in a protocol, or may be selected by the network device from several predefined reference signal patterns. This is not limited. A value of the quantity M of reference signal antenna ports that can be mapped to the second resource grid and a manner of mapping the M different reference signal antenna ports to the second resource grid are also not limited in this application. For example, a value of M may be 4, 6, 8, 12, 16, 24, or the like. For example, if M is

8, patterns of eight different reference signal antenna ports in the second resource grid may be shown in (a) in FIG. 2, or may be shown in a symbol 2 in (a) in FIG. 3. For another example, if M is 12, patterns of 12 different reference signal antenna ports in the second resource grid may be shown in (b) in FIG. 2, or may be shown in a symbol 2 in (b) in FIG. 3, or may be shown in a symbol 2 in (c) in FIG. 3. For another example, if M is 24, patterns of 24 different reference signal antenna ports in the second resource grid may be shown in (b) in FIG. 3 or (c) in FIG. 3.

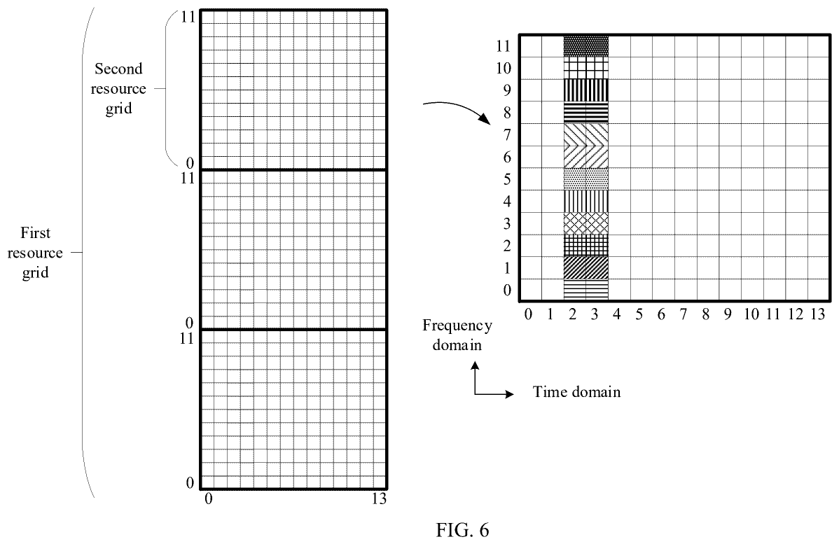

FIG. 6 shows a mapping pattern of a reference signal according to this application. As shown in FIG. 6, the first resource grid includes three second resource grids. That is, N=3. Each second resource grid corresponds to 12 subcarriers in frequency domain and 14 symbols in time domain. The figure shows a mapping pattern of a second resource grid located at a high position in frequency domain. It can be learned from the figure that if the configuration type is double symbols (for example, a reference signal antenna port is mapped to a symbol 2 and a symbol 3), the second resource grid shown on a right side of the figure may support mapping 24 different reference signal antenna ports (there are 12 filling patterns in total, each filling pattern corresponds to two REs, and each RE supports mapping one reference signal antenna port). Because a reference signal antenna port of each second resource grid is multiplexed in a same manner, that is, each second resource grid in the figure supports mapping 24 different reference signal antenna ports, the three second resource grids shown in FIG. 6 may support mapping 72 different reference signal antenna ports.

It should be understood that a position corresponding to the second resource grid corresponding to this application in time domain may include only a time domain resource on which the reference signal can be mapped. For example, in FIG. 6, the second resource grid in this application may include only 12 subcarriers in frequency domain and two symbols (namely, a symbol 2 and a symbol 3) in time domain.

In an embodiment, a value of N may be determined by the network device based on a value of a total quantity Q of to-be-mapped reference signal antenna ports (which may be referred to as a total quantity of to-be-mapped ports for short) and a value of a total quantity M of different reference signal antenna ports that can be mapped to the second resource grid (which may be referred to as a total quantity of ports supported by the second resource grid for short). For example, the following correspondence exists between N, Q, and M:

$$N = ⌈ \frac{Q}{M} ⌉ \qquad ( 1 )$$

An operation manner ┌ ┐ represents rounding up.

It should be understood that the first resource grid includes N second resource grids, which means that N resource grid units having a same multiplexing manner may be found in a pattern of the first resource grid. That the first resource grid includes N second resource grids may be replaced with that the first or second resource grid is determined based on a parameter set. The parameter set may include a value of N and a frequency domain density or other parameter information.

For example, the network device may determine the first or second resource grid based on parameters such as a total quantity Q of to-be-mapped ports, a total quantity M of ports that can be mapped to the second resource grid, reference signal density information, port multiplexing information, and time-frequency offset information of a port multiplexing group. A determining manner may be as follows.

The second resource grid may be determined based on parameters such as a total quantity M of ports that can be mapped to the second resource grid, port multiplexing information, and offset information of a port multiplexing group. In an embodiment, the port multiplexing information and the offset information of the port multiplexing group may jointly determine a type, a quantity, and a CDM position of the port multiplexing group. For example, cdm4-FD2-TD2 means that CDM4 occupies two subcarriers and two symbols. Therefore, 12 subcarriers and two symbols may be divided into six CDM groups. When a total quantity of ports that can be mapped to the second resource grid is 12, each CDM group can map two ports. A mapping manner may be sequential mapping, or may be another manner. This is not limited in this application.

It should be understood that, in this application, FD and TD respectively refer to frequency division multiplexing (frequency division) and time division multiplexing (time division).

In an embodiment, the second resource grid may also be determined based on parameters such as reference signal density information, port multiplexing information, and offset information of a port multiplexing group. In an embodiment, the port multiplexing information and the offset information of the port multiplexing group may jointly determine a type, a quantity, and a CDM position of the port multiplexing group. For example, cdm4-FD2-TD2 means that CDM4 occupies two subcarriers and two symbols. Therefore, 12 subcarriers and two symbols may be divided into six CDM groups. When the reference signal density information is 2, each port is mapped to two CDM groups. Similarly, a mapping manner may be sequential mapping, or may be another manner. This is not limited in this application.

Similarly, the first resource grid may be determined based on parameters such as a total quantity Q of to-be-mapped ports, information of total ports that can be mapped to the second resource grid, port multiplexing information, and offset information of a port multiplexing group. In an embodiment, the port multiplexing information and the offset information of the port multiplexing group jointly determine a type, a quantity, and a CDM position of the port multiplexing group. For example, cdm4-FD2-TD2 means that CDM4 occupies two subcarriers and two symbols. Therefore, 12 subcarriers and two symbols may be divided into six CDM groups. When the information of the total ports in the second resource grid is 12, each CDM group can map two ports. A mapping manner may be sequential mapping, or may be another manner. This is not limited in this application. Further, a quantity of second resource grids included in the first resource grid and a port arrangement manner may be determined based on the total quantity Q of the to-be-mapped ports. A port arrangement manner is not limited in this application.

The foregoing embodiment is merely an example of determining the first or second resource grid. There may be another manner of determining the first or second resource grid based on a combination of the parameters such as the total quantity Q of the to-be-mapped ports, the total quantity M of ports supported by the second resource grid, the reference signal density information, the port multiplexing information, and the time-frequency offset information of the port multiplexing group. Details are not described herein again.

S220: The terminal device determines the first resource grid, where the first resource grid includes the N second resource grids (components).

For descriptions of the first resource grid and the second resource grid, refer to S210. Details are not described herein again.

If a reference signal pattern of the second resource grid is selected by the network device from several predefined patterns, the network device may indicate, to the terminal device, a pattern selected by the network device.

In an embodiment, the network device may further indicate, to the terminal device, a total quantity Q of to-be-mapped reference signal antenna ports on the first resource grid or a value of N.

For example, the terminal device may determine the first resource grid or determine a reference signal pattern of the first resource grid based on a value of Q or the value of N, mapping manners of the M different reference signal antenna ports, and the multiplexing manners of the M reference signal antenna ports.

S230: The network device outputs a reference signal based on the first resource grid. Correspondingly, the terminal device inputs the reference signal based on the first resource grid.

In an embodiment, the network device may output the reference signal on the determined first resource grid for the terminal device, and the terminal device may input the reference signal on the determined first resource grid.

In an embodiment, the terminal device may perform channel estimation by using the received reference signal.

It should be understood that in this application, “outputting a reference signal or indication information” may be understood as sending a reference signal or indication information. In an architecture in which a central unit (CU) and a distribution unit (distributed unit, DU) are integrated, the network device includes the CU and the DU. That the network device outputs a reference signal or indication information may mean that the network device directly sends the reference signal or the indication information to the terminal device through an air interface. In an architecture in which the CU and the DU are separately deployed, the network device may include only the CU. In this architecture, that the network device outputs a reference signal or indication information may mean that the network device indirectly sends the reference signal or the indication information for the terminal device. The reference signal or the indication information needs to be forwarded by another device (a module, a unit, or the like, for example, the DU) to the terminal device through an air interface. As mentioned in this application, that the network device sends a reference signal or indication information to the terminal device includes the foregoing two cases.

Based on the foregoing solution, the network device and the terminal device may exchange the reference signal on the first resource grid. The first resource grid includes N units, and each unit supports mapping the M different reference signal antenna ports. Therefore, more reference signal antenna ports can be supported, and more reference signal antenna ports can be mapped to contiguous first resource grids, thereby helping improve a capacity of the reference signal.

In addition, because the multiplexing manners of the M reference signal antenna ports in each second resource grid are the same, a port multiplexing capability is improved, so that a reference signal pattern with a small quantity of ports is a subset of a reference signal pattern with a large quantity of ports, to implement a nested structure. In this way, complexity and power consumption of a receiver can be reduced.

In an embodiment, the method 200 further includes: The network device outputs first indication information, and correspondingly, the terminal device inputs the first indication information.

The first indication information may indicate a value of N, or the first indication information indicates a total quantity Q of to-be-mapped reference signal antenna ports on the first resource grid, and Q is a positive integer.

For example, in a process of sending a PDCCH, the network device may send the first indication information to the terminal device. For example, the first indication information may be carried in downlink control information (DCI) signaling. The DCI signaling may reuse an existing DCI field, for example, DCI signaling carried in antenna port indication. The DCI signaling may also be a newly added DCI field, and the DCI field is dedicated to carrying the first indication information.

For another example, in a process of sending a PDSCH, the network device may send the first indication information to the terminal device. For example, the first indication information may be carried in RRC signaling.

It should be understood that signaling carrying the first indication information may include at least one of the following: RRC signaling, a medium access control control element (MAC CE), and DCI, and a channel carrying the first indication information may include at least one of the following: a PDSCH and a PDCCH. This is not limited in this application.

In an embodiment, the method 200 further includes: The terminal device determines a time-frequency resource of the reference signal.

In an embodiment, the terminal device may determine, based on the first indication information, time-frequency resources to which all reference signal ports are actually mapped. For example, the terminal device may determine a resource position of any reference signal port in frequency domain based on the following formula (2):

k=└p/M┘*PRB_{size}+Δ (2)

Herein, k is a resource position of any reference signal port in the reference signal ports in frequency domain, p is an index of the reference signal port, PRB_{size} is a quantity of PRBs occupied by a reference signal on the second resource grid, and Δ is a subcarrier offset to which the reference signal on the second resource grid is mapped.

In an embodiment, the method 200 further includes: The network device and the terminal device separately determine a precoding resource block group.

The precoding resource block group includes X precoding resource blocks, the X precoding resource blocks correspond to X contiguous first resource grids, the first resource grid includes one of the X precoding resource blocks, two adjacent precoding resources blocks are separated by N−1 second resource grids, and X is a positive integer.

In an embodiment, a size of the precoding resource block may be the same as a size of the second resource grid. Therefore, the first resource grid may include one of X precoding resource blocks having a same precoding scheme. If the N second resource grids are contiguous in frequency domain, the X precoding resource blocks correspond to X first resource grids that are contiguous in frequency domain. If the N second resource grids are contiguous in time domain, the X precoding resource blocks correspond to X first resource grids that are contiguous in time domain.

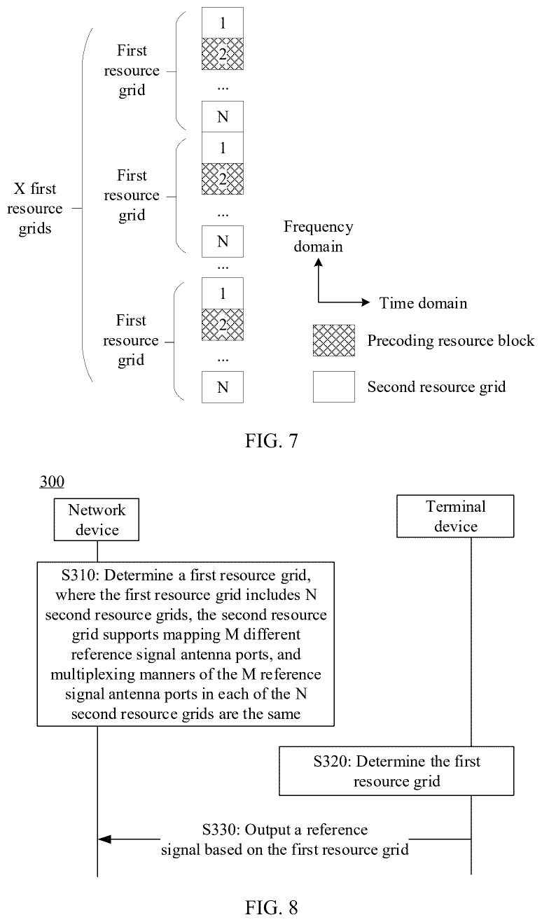

FIG. 7 is a diagram of a precoding resource block group according to this application. As shown in FIG. 7, an example in which the N second resource grids are contiguous in frequency domain is used. N second resource grids that are contiguous in frequency domain form a first resource grid, and each first resource grid corresponds to one precoding resource block. As shown in shaded areas in FIG. 7, X precoding resource blocks correspond to X contiguous first resource grids, and two adjacent precoding resource blocks are separated by N−1 second resource grids, and the X precoding resource blocks form the precoding resource block group.

In an embodiment, X is greater than 1, and the network device may determine the precoding resource block group in the following manner: The network device determines one precoding resource block every N−1 second resource grids. By repeating this process X times, the X precoding resource blocks may be determined. The X precoding resource blocks form the precoding resource block group.

In an embodiment, the method 200 further includes: The network device sends second indication information to the terminal device; and correspondingly, the terminal device receives the second indication information. The second indication information indicates a value of X.

The terminal device may determine the precoding resource block group in the following manner: The terminal device determines one precoding resource block every N−1 second resource grids. By repeating this process X times, the X precoding resource blocks may be determined, and the X precoding resource blocks form the precoding resource block group.

Further, the terminal device (the receive end) may perform channel estimation by using reference signals in the precoding resource block group together, to improve accuracy of channel estimation. In addition, the network device (the transmit end) may precode to-be-sent data and reference signals in the precoding resource block group in a same precoding manner.

Based on the foregoing solution, in this application, the precoding resource block group may be determined based on the first resource grid and the second resource grid, and the receive end may perform channel estimation by using the precoding resource block group. In this way, reliability of channel estimation and data demodulation at the receive end can be ensured.

In an embodiment, during RRC establishment, N may be a default value. In other words, the network device and the terminal device may determine the first resource grid by using a default value of N during RRC establishment, and input or output the reference signal based on the first resource grid.

The default value of N may be defined in a protocol. For example, the default value may be N=1. That is, the first resource grid and the second resource grid are equal in size.

In an embodiment, when N is the default value, X may also have a default value. For example, X may be 1 or 2 by default. In this case, that the network device or the terminal device determines the precoding resource block group includes: The network device or the terminal device determines one or two precoding resource blocks in one or two contiguous first resource grids, where the one or two contiguous precoding resource blocks are the precoding resource block group.

In an embodiment, the method 200 further includes: The network device performs rate matching on to-be-sent data based on the first resource grid. Correspondingly, the terminal device determines a resource corresponding to to-be-received data.

In an embodiment, if the position corresponding to the second resource grid in time

domain includes a time domain resource to which the reference signal is mapped and a time-frequency resource to which the data is mapped, the network device performs the rate matching on the to-be-sent data based on the first resource grid. In other words, the network device determines a resource in the first resource grid to which the reference signal is mapped, and maps the to-be-sent data to another resource in the first resource grid, to ensure that no conflict occurs between resources for the reference signal and the data.

In an embodiment, that the network device performs the rate matching on the to-be-sent data based on the first resource grid may be implemented in the following manners.

Manner 1: When the first indication information indicates the value of N, the network device performs the rate matching based on the value of N.

In an embodiment, the network device may determine a first resource, where the first resource is a resource other than resources occupied by M*N reference signal antenna ports on the first resource grid. Further, the network device may map the to-be-sent data on the first resource. The first resource may also be understood as a resource occupied by a data port on the first resource grid.

In this manner, the terminal device may alternatively first determine the first resource, and then receive, on the first resource, the data sent by the network device.

In an embodiment, when the first indication information indicates the value of N, the terminal device may consider all resources occupied by the M*N reference signal antenna ports as time-frequency resources to which the reference signals are mapped, and a resource other than the resources occupied by the M*N reference signal antenna ports on the first resource grid is the first resource. Then, the terminal device may receive data on the first resource.

It should be understood that, in this case, an actual size of the time-frequency resources to which the reference signals are mapped is less than or equal to a size of the resources occupied by the M*N reference signal antenna ports, or an actual quantity Q of reference signal antenna ports on the first resource grid is less than or equal to M*N.

Based on the foregoing solution, when the network device indicates the value of N to the terminal device, a rate matching method may be determined based on N. When receiving data, the terminal device does not need to determine an actual resource to which the reference signal is mapped, and directly receives the data on the resource other than the resources occupied by the M*N reference signal antenna ports. In this way, complexity of data demodulation at the terminal device can be reduced.

Manner 2: When the first indication information indicates the total quantity Q of the to-be-mapped reference signal antenna ports on the first resource grid, a rate matching scheme may be determined based on a value of Q.

In an embodiment, the network device may determine a second resource, where the second resource is a resource other than resources occupied by Q reference signal antenna ports on the first resource grid. Further, the network device may map the to-be-sent data on the second resource. The second resource may also be understood as a resource occupied by a data port on the first resource grid.

If Q is not divisible by M, there may be at least one second resource grid in the N second resource grids that only maps some of the M different reference signal antenna ports. In other words, if Q is not divisible by M, the value of Q is less than M*N.

In this manner, the terminal device may first determine the second resource, and then receive, on the second resource, the data sent by the network device.

In an embodiment, when the first indication information indicates the total quantity Q of the to-be-mapped reference signal antenna ports on the first resource grid, the terminal device may determine, according to formula (2), actual positions of the time-frequency resources to which the reference signals are mapped, that is, positions of the resources occupied by the Q reference signal antenna ports. The resource other than the resources occupied by the Q reference signal antenna ports on the first resource grid is the second resource. Then, the terminal device may receive data on the second resource.

Based on the foregoing solution, when the network device indicates, to the terminal device, the total quantity Q of the to-be-mapped reference signal antenna ports, a rate matching method may be determined based on Q. In this way, data can be mapped to positions other than an actual position of a time-frequency resource to which the reference signal is mapped, so that spatial domain or time-frequency domain resources can be fully utilized, and data transmission efficiency can be maximized.

In an embodiment, if the position corresponding to the second resource grid in time domain includes only a time domain resource to which the reference signal can be mapped, the network device performs the rate matching on the to-be-sent data based on the first resource grid. In other words, the network device determines a resource in the first resource grid to which the reference signal is mapped, and maps the to-be-sent data to another resource other than the first resource grid, to ensure that no conflict occurs between resources for the reference signal and the data.

FIG. 8 is a schematic flowchart of a communication method 300 according to an embodiment of this application. As shown in FIG. 8, the method 300 includes the following operations. The method 300 uses uplink as an example. In the uplink, for example, a transmit end is a terminal device, a receive end is a network device, and a reference signal is an uplink reference signal, for example, a DMRS or an SRS.

S310: The network device (the receive end) determines a first resource grid, where the first resource grid includes N second resource grids (components).

For a description of S310, refer to S210. Details are not described herein again.

S320: The terminal device (the transmit end) determines the first resource grid, where the first resource grid includes the N second resource grids.

For a description of S320, refer to S220. Details are not described herein again.

S330: The terminal device outputs a reference signal based on the first resource grid. Correspondingly, the network device inputs the reference signal based on the first resource grid.

In an embodiment, the network device may perform channel estimation by using the received reference signal.

It should be understood that in this application, “inputting a reference signal” may be understood as receiving a reference signal. In an architecture in which a CU and a DU are integrated, the network device includes the CU and the DU. That the network device inputs a reference signal may mean that the network device directly receives the reference signal through an air interface. In an architecture in which the CU and the DU are separately deployed, the network device may include only the CU. In this architecture, that the network device inputs a reference signal or indication information may mean that another device (a module, a unit, or the like) receives the reference signal or the indication information through an air interface, and inputs the reference signal or the indication information to the network device. In this application, that the terminal device sends the reference signal to the network device includes the foregoing two cases.

Based on the foregoing solution, the network device and the terminal device may exchange the reference signal on the first resource grid. The first resource grid includes N units, and each unit supports mapping the M different reference signal antenna ports. Therefore, more reference signal antenna ports can be supported, and more reference signal antenna ports can be mapped to contiguous first resource grids, thereby helping improve a capacity of the reference signal.

In addition, because the multiplexing manners of the M reference signal antenna ports in each second resource grid are the same, a port multiplexing capability is improved, so that a reference signal pattern with a small quantity of ports is a subset of a reference signal pattern with a large quantity of ports, to implement a nested (nested) structure. In this way, complexity and power consumption of a receiver can be reduced.

In an embodiment, the method 300 further includes: The network device outputs first indication information, and correspondingly, the terminal device inputs the first indication information.

For details of the foregoing process, refer to the descriptions of the method 200. Details are not described herein again.

In an embodiment, the method 300 further includes: The terminal device determines a time-frequency resource of the reference signal.

For details of the foregoing process, refer to the descriptions of the method 200. Details are not described herein again.

In an embodiment, the method 300 further includes: The network device and the terminal device separately determines a precoding resource block group.

For details of the foregoing process, refer to the descriptions of the method 200. A main difference from the method 200 lies in that, in the method 300, the network device (the receive end) may perform channel estimation by using reference signals in the precoding resource block group together, to improve accuracy of channel estimation. The terminal device (the transmit end) may precode to-be-sent data and reference signals in the precoding resource block group in a same precoding manner.

In an embodiment, during RRC establishment, N may be a default value. In other words, the network device and the terminal device may determine the first resource grid by using a default value of N during RRC establishment, and input or output the reference signal based on the first resource grid.

In an embodiment, the method 300 further includes: The terminal device performs rate matching on to-be-sent data based on the first resource grid. Correspondingly, the network device determines a resource corresponding to to-be-received data.

In an embodiment, that the terminal device performs the rate matching on the to-be-sent data based on the first resource grid may mean that the terminal device determines a resource in the first resource grid to which the reference signal is mapped, and maps the to-be-sent data to another resource, to ensure that no conflict occurs between resources for the reference signal and the data.

For details of the foregoing process, refer to the descriptions of the method 200. Details are not described herein again.

It should be understood that a difference between the method 300 and the method 200 lies in that roles of the transmit end and the receive end change. Therefore, both the transmit end and the receive end of the reference signal and the data change. Therefore, related processing of “rate matching” performed by the network device in the method 200 is performed by the terminal device in the method 300. However, in the method 300, a resource used by the terminal device to send the reference signal, the first indication information, the second indication information, and the like are still indicated by the network device.

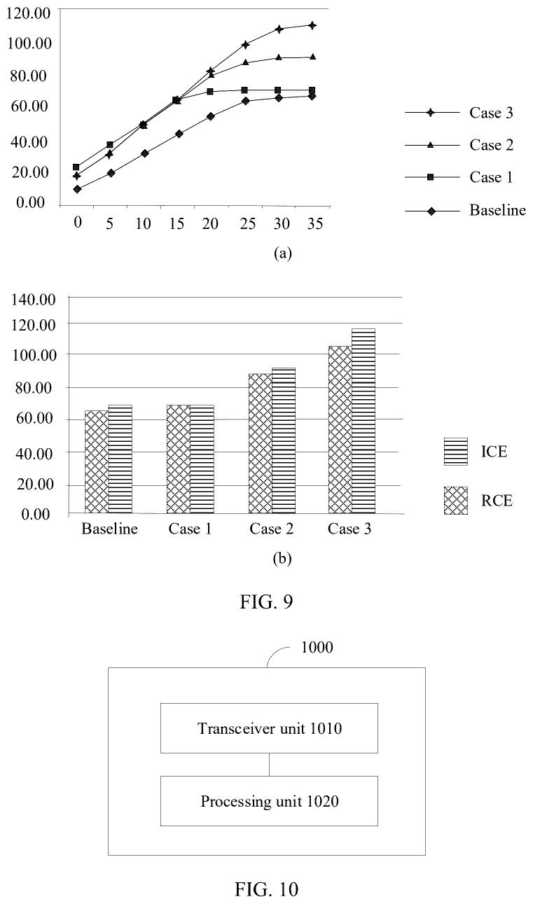

FIG. 9 is a diagram of spectral efficiency (spectral efficiency, SE) according to an embodiment of this application. A spectral efficiency result in FIG. 9 is a result implemented based on the method 200 in this application. (a) in FIG. 9 is a diagram of a change of spectral efficiency SE of ideal channel estimation (realistic channel estimation, RCE) with a signal-to-noise ratio (signal-noise ratio, SNR) in different cases. (b) in FIG. 9 is a diagram of comparison between SE of realistic channel estimation (ideal channel estimation, ICE) and RCE in different cases. (b) in FIG. 9 shows a result with the signal-to-noise ratio configured as 30 dB. In FIG. 9, a baseline (baseline), a case 1, a case 2, and a case 3 respectively correspond to SE results of different quantities of ports, quantities of paired UEs, scheduling algorithms, and modulation orders, which are shown in Table 1. Herein, that a modulation algorithm is quadrature amplitude modulation (quadrature amplitude modulation, QAM) is used as an example. A quantity of ports in Table 1 is a total quantity of reference signal ports that can be mapped to the first resource grid.

TABLE 1

| | Modulation | | Quantity | Quantity | Whether there is a |
|---|---|---|---|---|---|
| | algorithm | | of | of paired | scheduling |
| Case | (QAM) | | ports | UEs | algorithm |
| Baseline | 64 | QAM | 24 | 12 | No |
| (baseline) | | | | | |
| Case 1 | 64 | QAM | 24 | 24 | Yes |
| (case 1) | | | | | |
| Case 2 | 64 | QAM | 32 | 24 | Yes |
| (case 2) | | | | | |
| Case 3 | 256 | QAM | 32 | 24 | Yes |
| (case 3) | | | | | |

It can be learned from different cases in (a) in FIG. 9 that, as a total quantity of reference signal ports that can be mapped to the first resource grid increases (for example, from 24 ports to 32 ports), the SE continues to show a significant improvement when the signal-to-noise ratio is medium or high (for example, greater than 30 dB), sufficiently demonstrating effectiveness of the method 200 in this application.

It can be learned from (b) in FIG. 9 that, when the signal-to-noise ratio is medium or high, an estimation performance loss of realistic channel estimation is minimal compared with that of ideal channel estimation, sufficiently demonstrating reliability of the method 200 in this application.

Corresponding to the methods provided in the foregoing method embodiments, an embodiment of this application further provides a corresponding apparatus. The apparatus includes a corresponding module configured to perform the foregoing method embodiments. The module may be software, hardware, or a combination of software and hardware. It may be understood that the technical features described in the method embodiments are also applicable to the following apparatus embodiments.

In an example, FIG. 10 is a block diagram of a communication apparatus 1000 according to an embodiment of this application. The apparatus 1000 includes a transceiver unit 1010 and a processing unit 1020. The transceiver unit 1010 may be configured to implement a corresponding communication function. The transceiver unit 1010 may also be referred to as a communication interface or a communication unit. The processing unit 1020 may be configured to implement a corresponding processing function.

In an embodiment, the apparatus 1000 is configured to perform the operations or the procedures performed by the transmit end in the embodiment shown in FIG. 5 or FIG. 8.

For example, the processing unit 1020 is configured to determine a first resource grid. The first resource grid includes N second resource grids, the second resource grid supports mapping M different reference signal antenna ports, multiplexing manners of the M reference signal antenna ports in each of the N second resource grids are the same, and both N and M are positive integers. The transceiver unit 1010 is configured to output a reference signal based on the first resource grid.

It should be understood that the foregoing content is merely used as an example for understanding. The apparatus 1000 can further implement other operations, actions, or methods related to the transmit end in the method 200 or the method 300. Details are not described herein.

A process in which the units perform the foregoing corresponding operations is described in detail in the foregoing method embodiments. For brevity, details are not described herein.

In embodiment, the apparatus 1000 is configured to perform operations or procedures performed by the receive end in the embodiment shown in FIG. 5 or FIG. 8.

For example, the processing unit 1020 is configured to determine a first resource grid. The first resource grid includes N second resource grids, the second resource grid supports mapping M different reference signal antenna ports, multiplexing manners of the M reference signal antenna ports in each of the N second resource grids are the same, and both N and M are positive integers. The transceiver unit 1010 is configured to input a reference signal based on the first resource grid.

It should be understood that the foregoing content is merely used as an example for understanding. The apparatus 1000 can further implement other operations, actions, or methods related to the receive end in the method 200 or the method 300. Details are not described herein. A process in which the units perform the foregoing corresponding operations is

described in detail in the foregoing method embodiments. For brevity, details are not described herein.

It should be understood that the apparatus 1000 herein is embodied in a form of a functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function.

For example, a product embodiment form of the apparatus 1000 provided in this embodiment of this application is program code that can be run on a computer.

For example, the apparatus 1000 provided in this embodiment of this application may be a communication device, or may be a chip, a chip system (for example, a system on chip (system on chip, SoC)), or a circuit used in the communication device. When the apparatus 1000 is a communication device, the transceiver unit 1010 may be a transceiver or an input/output interface, and the processing unit 1020 may be a processor. When the apparatus 1000 is a chip, a chip system, or a circuit used in the communication device, the transceiver unit 1010 may be an input/output interface, an interface circuit, an output circuit, an input circuit, a pin, a related circuit, or the like on the chip, the chip system, or the circuit; and the processing unit 1020 may be a processor, a processing circuit, a logic circuit, or the like.

In addition, the transceiver unit 1010 may alternatively be a transceiver circuit (for example, the transceiver circuit may include a receiver circuit and a transmitter circuit), and the processing unit may be a processing circuit.

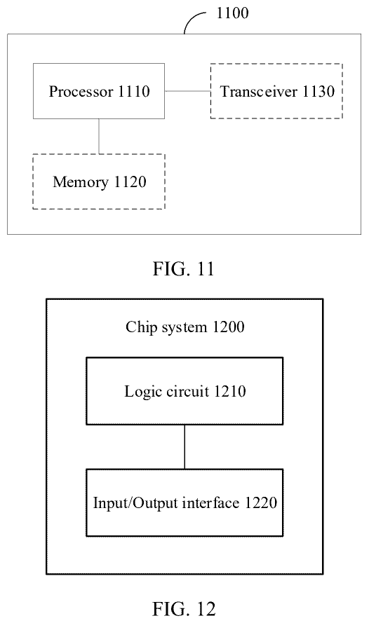

In an example, FIG. 11 is a block diagram of a communication apparatus 1100 according to an embodiment of this application. The apparatus 1100 includes a processor 1110, and the processor 1110 is coupled to a memory 1120. In an embodiment, the apparatus further includes the memory 1120, configured to store a computer program or instructions and/or data. The processor 1110 is configured to execute the computer program or the instructions stored in the memory 1120, or read the data stored in the memory 1120, to perform the methods in the foregoing method embodiments.

In an embodiment, there are one or more processors 1110.

In an embodiment, there are one or more memories 1120.

In an embodiment, the memory 1120 and the processor 1110 are integrated together or separately disposed.

In an embodiment, as shown in FIG. 11, the apparatus 1100 further includes a transceiver 1130. The transceiver 1130 is configured to receive and/or send a signal. For example, the processor 1110 is configured to control the transceiver 1130 to receive and/or send the signal.

In a solution, the apparatus 1100 is configured to implement the operations performed by the transmit end in the foregoing method embodiments.

For example, the processor 1110 is configured to execute the computer program or the instructions stored in the memory 1120, to implement related operations performed by the transmit end in the foregoing method embodiments, for example, the method performed by the network device in the embodiment shown in FIG. 5, or the method performed by the terminal device in the embodiment shown in FIG. 8.

In another solution, the apparatus 1100 is configured to implement operations performed by the receive end in the foregoing method embodiments.

For example, the processor 1110 is configured to execute the computer program or the instructions stored in the memory 1120, to implement related operations performed by the receive end in the foregoing method embodiments, for example, the method performed by the terminal device in the embodiment shown in FIG. 5, or the method performed by the network device in the embodiment shown in FIG. 8.

In an embodiment, operations in the foregoing methods may be implemented by using a hardware integrated logic circuit in the processor 1110, or by using instructions in a form of software. The method disclosed with reference to embodiments of this application may be directly performed by a hardware processor, or may be performed by using a combination of hardware in the processor and a software module. A software module may be located in a mature storage medium in the art, such as a random access memory, a flash memory, a read-only memory, a programmable read-only memory, an electrically erasable programmable memory, or a register. The storage medium is located in the memory 1120, and the processor 1110 reads information in the memory 1120 and completes the operations of the foregoing methods in combination with hardware of the processor. To avoid repetition, details are not described herein again.

It should be understood that, in embodiments of this application, the processor may be one or more integrated circuits, and is configured to execute a related program, to perform the method embodiments of this application.

The processor (for example, the processor 1110) may include one or more processors and be implemented as a combination of computing devices. The processor may include one or more of the following: a microprocessor, a microcontroller, a digital signal processor (DSP), a digital signal processing device (DSPD), an application-specific integrated circuit (ASIC), a field programmable gate array (FPGA), a programmable logic device (PLD), gating logic, transistor logic, a discrete hardware circuit, a processing circuit, or other appropriate hardware, firmware, and/or a combination of hardware and software, and is configured to perform various functions described in this disclosure. The processor may be a general-purpose processor or a special-purpose processor. For example, the processor 1110 may be a baseband processor or a central processing unit. The baseband processor may be configured to process a communication protocol and communication data. The central processing unit may be configured to enable the apparatus to execute a software program and process data in the software program. A part of the processor may further include a non-volatile random access memory. For example, the processor may further store information of a device type.

The program in this application represents software in a broad sense. A non-limiting example of the software includes program code, a program, a subprogram, instructions, an instruction set, code, a code segment, a software module, an application, a software application, or the like. The program may be run in a processor and/or a computer, to enable the apparatus to perform various functions and/or processes described in this application.

The memory (for example, the memory 1120) may store data required by the processor (for example, the processor 1110) during software execution. The memory may be implemented by using any suitable storage technology. For example, the memory may be any available storage medium that can be accessed by the processor and/or the computer. A non-limiting example of the storage medium includes: a random access memory (RAM), a read-only memory (ROM), an electrically erasable programmable read-only memory (EEPROM), a compact disc read-only memory (CD-ROM), a static random access memory (SRAM), a dynamic random access memory (dynamic RAM, DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), a direct rambus random access memory (DR RAM), a removable medium, optical disc storage, a magnetic disk storage medium, a magnetic storage device, a flash memory, a register, a status memory, remote mounted storage, a local or remote storage component, or any other medium capable of carrying or storing software, data or information and accessible by a processor/computer. It should be noted that the memory described in this specification is intended to include but is not limited to these memories and any memory of another appropriate type.

The memory (for example, the memory 1120) and the processor (for example, the processor 1110) may be separately disposed or integrated together. The memory may be configured to connect to the processor, so that the processor can read information from the memory, and store and/or write information into the memory. The memory may be integrated into the processor. The memory and the processor may be disposed in an integrated circuit (for example, the integrated circuit may be disposed in a UE, a BS, or another network node).

In an example, FIG. 12 is a block diagram of a chip system 1200 according to an embodiment of this application. The chip system 1200 (which may also be referred to as a processing system) includes a logic circuit 1210 and an input/output interface (input/output interface) 1220.

The logic circuit 1210 may be a processing circuit in the chip system 1200. The logic circuit 1210 may be coupled and connected to a storage unit, and invoke instructions in the storage unit, so that the chip system 1200 can implement methods and functions in embodiments of this application. The input/output interface 1220 may be an input/output circuit in the chip system 1200, and outputs information processed by the chip system 1200, or inputs to-be-processed data or signaling information to the chip system 1200 for processing.

In a solution, the chip system 1200 is configured to implement the operations performed by the transmit end in the method embodiments.

For example, the logic circuit 1210 is configured to implement processing-related operations performed by the transmit end in the foregoing method embodiments, for example, processing-related operations performed by the network device in the embodiment shown in FIG. 5, or processing-related operations performed by the terminal device in the embodiment shown in FIG. 8. The input/output interface 1220 is configured to implement sending and/or receiving-related operations performed by the transmit end in the foregoing method embodiments, for example, sending and/or receiving-related operations performed by the network device in the embodiment shown in FIG. 5, or sending and/or receiving-related operations performed by the terminal device in the embodiment shown in FIG. 8.

In another solution, the chip system 1200 is configured to implement the operations performed by the receive end in the method embodiments.

For example, the logic circuit 1210 is configured to implement processing-related operations performed by the receive end in the foregoing method embodiments, for example, processing-related operations performed by the terminal device in the embodiment shown in FIG. 5, or processing-related operations performed by the network device in the embodiment shown in FIG. 8. The input/output interface 1220 is configured to implement sending and/or receiving-related operations performed by the receive end in the foregoing method embodiments, for example, sending and/or receiving-related operations performed by the terminal device in the embodiment shown in FIG. 5, or sending and/or receiving-related operations performed by the network device in the embodiment shown in FIG. 8.

An embodiment of this application further provides a computer-readable storage medium. The computer-readable storage medium stores computer instructions used to implement the method performed by the transmit end or the receive end in the foregoing method embodiments.

An embodiment of this application further provides a computer program product, including instructions. When the instructions are executed by a computer, the method performed by the transmit end or the receive end in the foregoing method embodiments is implemented.

For explanations and beneficial effects of related content in any one of the apparatuses provided above, refer to the corresponding method embodiments provided above. Details are not described herein again.

In the several embodiments provided in this application, it should be understood that the disclosed apparatus and method may be implemented in other manners. For example, the foregoing apparatus embodiments are only examples. For example, division into the foregoing units is only logical function division, and may be another division manner during actual embodiment. For example, a plurality of units or components may be combined or integrated into another system, or some features may be ignored or not performed. In addition, the displayed or discussed mutual couplings or direct couplings or communication connections may be indirect couplings or communication connections through some interfaces, apparatuses, or units, and may be in electrical, mechanical, or other forms.

The foregoing units described as separate parts may or may not be physically separate, and parts displayed as units may or may not be physical units, may be located in one position, or may be distributed on a plurality of network units. Some or all of the units may be selected based on actual requirements to implement the solutions provided in this application.

In addition, functional units in embodiments of this application may be integrated into one unit, each of the units may exist alone physically, or two or more units may be integrated into one unit.

A person of ordinary skill in the art may be aware that, in combination with the examples described in embodiments disclosed in this specification, units and algorithm operations may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the embodiment goes beyond the scope of this application.

When software is used to implement embodiments, the foregoing embodiments may be implemented completely or partially in a form of a computer program product. The computer program product includes one or more computer instructions. When the computer program instructions are loaded and executed on the computer, the procedures or functions according to embodiments of this application are completely or partially generated. The computer may be a general-purpose computer, a dedicated computer, a computer network, or other programmable apparatuses. For example, the computer may be a personal computer, a server, or a network device. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. For the computer-readable storage medium, refer to the foregoing descriptions.

The foregoing descriptions include embodiment various embodiments, but the protection scope of this application may extend beyond the embodiments described. Any variation or replacement readily figured out by a person skilled in the art within the technical scope disclosed in this application shall fall within the protection scope of this application. The protection scope of this application shall be subject to the protection scope of the claims.

1. A communication method, comprising:
determining, by a transmit end, a first resource grid, wherein the first resource grid comprises N second resource grids, each of the N second resource grids supports mapping M different reference signal antenna ports, multiplexing manners of the M different reference signal antenna ports in each of the N second resource grids are the same, and both N and M are positive integers; and
outputting, by the transmit end, a reference signal based on the first resource grid.

2. The method according to claim 1, wherein a value of M is any one of the following: 4, 6, 8, 12, 16, or 24.

3. The method according to claim 1, wherein the method further comprises:
outputting, by the transmit end, first indication information, wherein the first indication information indicates a value of N, or the first indication information indicates a total quantity Q of to-be-mapped reference signal antenna ports on the first resource grid, and Q is a positive integer.

4. The method according to claim 1, wherein the method further comprises:
inputting, by the transmit end, first indication information, wherein the first indication information indicates a value of N, or the first indication information indicates a total quantity Q of to-be-mapped reference signal antenna ports on the first resource grid, and Q is a positive integer.

5. The method according to claim 1, wherein the method further comprises:
determining, by the transmit end, a precoding resource block group, wherein the precoding resource block group comprises X precoding resource blocks, the X precoding resource blocks correspond to X contiguous first resource grids, the first resource grid comprises one of the X precoding resource blocks, any two adjacent precoding resource blocks in the X precoding resource blocks are separated by N−1 second resource grids, and X is a positive integer.

6. The method according to claim 5, wherein determining, by the transmit end, the precoding resource block group comprises:
determining, by the transmit end, one precoding resource block every N−1 second resource grids; and
determining, by the transmit end, the X precoding resource blocks, wherein the X precoding resource blocks form the precoding resource block group, and X is greater than 1.

7. The method according to claim 5, wherein the method further comprises:
outputting, by the transmit end, second indication information, wherein the second indication information indicates a value of X.

8. A communication method, comprising:
determining, by a receive end, a first resource grid, wherein the first resource grid comprises N second resource grids, each of the N second resource grids supports mapping M different reference signal antenna ports, multiplexing manners of the M different reference signal antenna ports in each of the N second resource grids are the same, and both N and M are positive integers; and
inputting, by the receive end, a reference signal based on the first resource grid.

9. The method according to claim 8, wherein a value of M is any one of the following: 4, 6, 8, 12, 16, or 24.

10. The method according to claim 8, wherein the method further comprises:
inputting, by the receive end, first indication information, wherein the first indication information indicates a value of N, or the first indication information indicates a total quantity Q of to-be-mapped reference signal antenna ports on the first resource grid, and Q is a positive integer.

11. The method according to claim 8, wherein the method further comprises:
outputting, by the receive end, first indication information, wherein the first indication information indicates a value of N, or the first indication information indicates a total quantity Q of to-be-mapped reference signal antenna ports on the first resource grid, and Q is a positive integer.

12. The method according to claim 8, wherein the method further comprises:
determining, by the receive end, a precoding resource block group, wherein the precoding resource block group comprises X precoding resource blocks, the X precoding resource blocks correspond to X contiguous first resource grids, the first resource grid comprises one of the X precoding resource blocks, each of the X precoding resource blocks is separated by N−1 second resource grids, and X is a positive integer.

13. The method according to claim 12, wherein determining, by the receive end, the precoding resource block group comprises:
determining, by the receive end, one precoding resource block every N−1 second resource grids; and
determining, by the receive end, the X precoding resource blocks, wherein the X precoding resource blocks form the precoding resource block group, and X is greater than 1.

14. The method according to claim 12, wherein the method further comprises:
outputting, by the receive end, second indication information, wherein the second indication information indicates a value of X.

15. A communication apparatus, comprising: at least one processor, and one or more memories coupled to the at least one processor and storing programming instructions for execution by the at least one processor to perform operations comprising:
determining a first resource grid, wherein the first resource grid comprises N second resource grids, each of the N second resource grids supports mapping M different reference signal antenna ports, multiplexing manners of the M different reference signal antenna ports in each of the N second resource grids are the same, and both N and M are positive integers; and
inputting a reference signal based on the first resource grid.

16. The communication apparatus according to claim 15, wherein a value of M is any one of the following: 4, 6, 8, 12, 16, or 24.

17. The communication apparatus according to claim 15, wherein the operations further comprise:
first indication information, wherein the first indication information indicates a value of N, or the first indication information indicates a total quantity Q of to-be-mapped reference signal antenna ports on the first resource grid, and Q is a positive integer.

18. The communication apparatus according to claim 15, wherein the operations further comprise:
outputting first indication information, wherein the first indication information indicates a value of N, or the first indication information indicates a total quantity Q of to-be-mapped reference signal antenna ports on the first resource grid, and Q is a positive integer.

19. The communication apparatus according to claim 15, wherein the operations further comprise:
determining a precoding resource block group, wherein the precoding resource block group comprises X precoding resource blocks, the X precoding resource blocks correspond to X contiguous first resource grids, the first resource grid comprises one of the X precoding resource blocks, each of the X precoding resource blocks is separated by N−1 second resource grids, and X is a positive integer.

20. The communication apparatus according to claim 19, wherein the operations further comprise:
determining one precoding resource block every N−1 second resource grids; and
determining the X precoding resource blocks, wherein the X precoding resource blocks form the precoding resource block group, and X is greater than 1.
